(19) United States
(12) Patent Application Publication
(10) Pub. No.: US 2012/0213906 A1
(43) Pub. Date: Aug. 23, 2012

(54) DAIRY PRODUCT AND PROCESS

(75) Inventors: Paul Andreas Deuritz, Palmerston North (NZ); David Campbell Wemyss Reid, Palmerston North (NZ); Alexandra Kay Legg, Palmerston North (NZ)

(73) Assignee: FONTERRA CO-OPERATIVE GROUP LIMITED, Auckland (NZ)

(21) Appl. No.: 13/402,743

(22) Filed: Feb. 22, 2012

Related U.S. Application Data
(63) Continuation-in-part of application No. PCT/NZ2011/000160, filed on Aug. 18, 2011.

(30) Foreign Application Priority Data
Aug. 20, 2010 (NZ) 587486

(51) Int. Cl. A23C 19/082; A23L 1/035

(52) U.S. Cl. 426/582; 426/654

(57) ABSTRACT

The invention provides methods for preparing processed cheese and processed cheese products having reduced sodium content, while retaining desirable organoleptic characteristics, processability, food safety attributes and functional characteristics normally associated with processed cheese or processed cheese products having normal sodium content, and the processed cheeses and processed cheese products so produced.

### FIELD OF THE INVENTION

The present invention relates to a method of preparing a processed cheese and to processed cheese products made by the method.

### BACKGROUND OF THE INVENTION

Processed cheese is a food made by heating and mixing of natural cheeses with a combination of milkfat, water, salt, colour, flavour additives, fortifying agents, gelling agents and/or preservatives, in the presence of emulsifying salts. The emulsifying salts ensure that the blended ingredients melt smoothly and prevent fat separation during heating. Traditional manufacturing procedures for making processed cheese thus involve the cooking and melting of traditional cheeses, such as cheddar, with emulsifying salts.

Processed cheese has a number of technical advantages over unprocessed cheese, including extended shelf-life and reduced need for refrigeration, resistance to the separation of both free fat and also cheese serum when cooked, and the ability to reuse scraps, trimmings and runoff from other cheesemaking processes. Thus, the manufacture of processed cheese is partly driven by the useful conversion of low value scrap cheese into valuable products, and partly by a desire to deliver cheese products in many different formats and with a variety of flavours and functionalities.

Emulsifying salts play a vital role in the manufacture of processed cheese. One of the typical uses of emulsifiers in processed cheese results in cheese that melts smoothly when cooked. With prolonged heating, unprocessed cheese will separate into a molten protein gel and free liquid fat, while the natural cheese casein coagulation will rupture to provide free serum. Processed cheese will not separate in this manner. The emulsifiers, typically sodium or potassium phosphates, tartrates, or citrates, reduce the tendency for tiny fat globules in the cheese to coalesce and pool on the surface of the molten cheese. Because processed cheese does not separate when melted, it is used as an ingredient in a variety of dishes. For example, it is a popular condiment on hamburgers, where the melting and taste characteristics as it is heated are well matched to the application.

Emulsifying salts dissociate during processed cheese manufacture to release monovalent cations, such as sodium, and the associated anions, such as phosphate or citrate. A significant amount of the monovalent cations subsequently exchange with a portion of the divalent cations, such as calcium, normally bound to the casein micelles. Casein micelles constitute the major protein in milk and are coagulated by rennet to produce natural cheese coagulum. However, the bonding of multiple casein molecules together by divalent cations to create casein micelles, significantly reduces the ability of these proteins to emulsify fat. The cation exchange facilitated by added emulsifying salt inserts monovalent cations into the caseins, dispersing the micellar casein and transforming the shape of the individual caseins into conformations with the polarized, amphipathic properties of soaps. The conformational change resulting from this exchange increases the solubility of the casein and enhances the ability of the available casein to emulsify fat, thereby preventing the formation of free fat during cooking.

Differences between the anions and cations of the various emulsifying salts create distinctive differences in the flavour, melting ability, body, and texture in the finished processed cheese. Emulsifying salts can also assist in providing acceptable storage properties by decreasing the growth of microbial pathogens. However, the use of emulsifying salts typically results in products with a relatively high sodium content.

There are currently major health concerns around excessive dietary intake of sodium. Hence there is a drive to reduce the sodium levels in food, particularly in foods such as processed cheese. However, sodium and its salts play important roles in processed cheese. In addition to the emulsification role, they contribute to the overall flavour, functionality, and microbiological stability of the product. The majority of attempts to reduce the sodium levels in processed cheese have lead to products with compromised flavour and/or shelf-life. Indeed, many regulatory bodies have advised manufacturers to be extremely vigilant in assessing shelf-life of reduced-sodium food products (see, for example, the U.K. Food Standards Agency's Advisory Committee on the Microbiological Safety of Food (ACMSF) recommendations).

It is an object of the present invention to go some way towards providing a processed cheese with a reduced sodium content, preferably while retaining desirable food safety attributes, organoleptic properties, texture, functionality, microbiological stability attributes similar to that of processed cheese containing conventional levels of sodium, and/or to provide the public with a useful choice.

### DISCLOSURE OF THE INVENTION

The present invention enables a reduction in the sodium content in processed cheese manufacture. The present invention also provides for processed cheese and related products produced with lower salt and/or sodium content, but with organoleptic properties, functional properties, processability and food safety attributes the same as or comparable to standard non-sodium-reduced processed cheese or related product. The lower sodium contents are provided by replacing sodium salts with an emulsifying system comprising potassium salts and/or milk protein sources functionalised for emulsification, such as a reduced calcium milk protein concentrate.

One aspect of the invention provides a method for preparing processed cheese or a processed cheese product comprising:
(a) providing a dairy liquid composition or a gelled dairy composition or both, comprising casein;
(b) cooking the composition or the combination of compositions with emulsifying salts to obtain an emulsion, and
(c) cooling the cooked composition to obtain a processed cheese or a processed cheese product;
   wherein the emulsifying salts comprise by weight 10-100% of potassium salts, for example 25-70%.

In one embodiment, the emulsifying salts comprise potassium citrate.

In a further embodiment, the emulsifying salts comprise potassium citrate and trisodium citrate.

In one embodiment, the emulsifying salts consist of potassium citrate and sodium citrate, for example tripotassium citrate or trisodium citrate.

In a further exemplary embodiment, the emulsifying salts consist of tripotassium citrate and less than about 40% w/w trisodium citrate.

The invention further provides a method for preparing processed cheese or a processed cheese product comprising:
(a) providing a dairy liquid composition or a gelled dairy composition or both,
(b) cooking the composition or the combination of compositions with an emulsifying system to obtain an emulsion, and
(c) cooling the cooked composition to obtain a processed cheese or a processed cheese product;
   wherein the emulsifying system comprises, consists essentially of, or consists of:
i. by weight 10-100% of potassium salts, for example 25-70%; or
ii. by weight 0-100% of sodium salts, for example 25-70%; or
iii. any combination of i) and ii); and
iv. by weight 10-100% one or more milk protein source, for example 25-70%.

In one embodiment, the milk protein source is functionalised for emulsification.

In one embodiment, the milk protein source comprises casein, including casein at least part of which has a proportion, for example at least 5%, for example at least 10%, of its divalent ions, including calcium ions, replaced with sodium or potassium ions

In a preferred embodiment, the dairy liquid composition is a retentate produced by processing milk using membrane technology, preferably ultrafiltration and optional diafiltration.

In preferred embodiments the composition to be cooked includes cheese or ultrafiltration cheese.

In typical processed cheese manufacture the cheese or ultrafiltration cheese provides 20% to 80% of the total solids. The emulsifier system typically provides 0-6% of the total solids. Sodium chloride typically provides 1.5% to 4% of the total solids. Typically the processed cheese comprises 30-60% moisture. The ingredients and their proportions are chosen to result in such a moisture content. Part of the water may be condensate when heating with steam is used. Water may be included as an ingredient if required. The moisture and fat contents of the processed cheese can be varied to adjust the properties of the processed cheese such as melt, body, texture, and spreadability.

In another aspect, the invention provides a method for preparing processed cheese or a processed cheese product comprising:
(a) providing a dairy liquid composition or a gelled dairy composition or both, comprising casein;
(b) cooking the composition or the combination of compositions with an emulsifying system to obtain an emulsion, and
(c) cooling the cooked composition to obtain a processed cheese or a processed cheese product;
   wherein the emulsifying system comprises at least one milk protein source, for example a milk protein concentrate, and at least one emulsifying salt.

In various embodiments, the emulsifying system comprises from about 0.1% w/w to about 15% w/w of the processed cheese. For example, the emulsifying system comprises from about 1% w/w to about 6% w/w of the processed cheese, from about 1% w/w to about 5.5% w/w of the processed cheese, from about 1% w/w to about 5% w/w of the processed cheese, from about 1% w/w to about 4.5% w/w of the processed cheese, from about 1.5% w/w to about 6% w/w of the processed cheese, from about 1.5% w/w to about 5.5% w/w of the processed cheese, from about 1.5% w/w to about 5% w/w of the processed cheese, from about 1.5% w/w to about 4.5% w/w of the processed cheese, from about 2% w/w to about 6% w/w of the processed cheese, from about 2% w/w to about 5.5% w/w of the processed cheese, from about 2% w/w to about 5% w/w of the processed cheese, from about 2% w/w to about 4.5% w/w of the processed cheese, from about 2.5% w/w to about 6% w/w of the processed cheese, from about 2.5% w/w to about 5.5% w/w of the processed cheese, from about 2.5% w/w to about 5% w/w of the processed cheese, from about 2.5% w/w to about 4.5% w/w of the processed cheese, from about 3% w/w to about 6% w/w of the processed cheese, from about 3% w/w to about 5.5% w/w of the processed cheese, from about 3% w/w to about 5% w/w of the processed cheese, or from about 3% w/w to about 4.5% w/w of the processed cheese.

In other representative embodiments, the emulsifying system comprises from about 0.5% w/w to about 4.5% w/w of the processed cheese, for example from about 0.5% w/w to about 4% w/w of the processed cheese, from about 0.5% w/w to about 3.5% w/w of the processed cheese, from about 0.5% w/w to about 3% w/w of the processed cheese, from about 0.5% w/w to about 2.5% w/w of the processed cheese, from about 1% w/w to about 4.5% w/w of the processed cheese, from about 1% w/w to about 4% w/w of the processed cheese, from about 1% w/w to about 3.5% w/w of the processed cheese, from about 1% w/w to about 3% w/w of the processed cheese, from about 1% w/w to about 2.5% w/w of the processed cheese, from about 1.5% w/w to about 4.5% w/w of the processed cheese, from about 1.5% w/w to about 4% w/w of the processed cheese, from about 1.5% w/w to about 3.5% w/w of the processed cheese, from about 1.5% w/w to about 3% w/w of the processed cheese, from about 1.5% w/w to about 2.5% w/w of the processed cheese.

In one embodiment, the emulsifying system comprises from about 3% w/w to about 6% w/w of the processed cheese, for example from about 3% w/w to about 5.5% w/w, from about 3% w/w to about 5% w/w, from about 3% w/w to about 4.5% w/w, from about 3% w/w to about 4% w/w, or from about 3.5% w/w to about 4% w/w of the processed cheese.

In certain exemplary embodiments, for example when the emulsifying system comprises from about 0.5% w/w to about 3.5% w/w of the processed cheese, the emulsifying system comprises at least about 40% w/w of at least one milk protein source, for example, at least about 40% w/w of the emulsifying system is a milk protein concentrate.

In one embodiment, the emulsifying system consists of at least one milk protein source, for example a milk protein concentrate and an emulsifying salt, and wherein the emulsifying salt comprises at least 10% by weight of the emulsifying system, for example at least about 15% by weight of the emulsifying system, or at least about 20% by weight of the emulsifying system.

In one exemplary embodiment, the milk protein source for use in the present invention is a calcium-reduced milk protein source. In one embodiment, the milk protein source comprises between 0.1% and 99.9% of the emulsifying system.

In one exemplary embodiment, the calcium-reduced milk protein source for use in the present invention is NZMP™ Milk Protein Concentrate 4864. The manufacturing process for this ingredient is described in PCT application PCT/NZ2004/000154, published as WO2005/009138 A1.

In various embodiments, the emulsifying system comprises any one of:
i. by weight 20-75% of potassium salts;
ii. by weight 20-70% of potassium salts;
iii. by weight 30-70% of potassium salts;
iv. by weight 30-60% of potassium salts;
v. by weight 35-60% of potassium salts;
vi. by weight 40-60% of potassium salts;
vii. by weight 45-60% of potassium salts;
viii. by weight 45-55% of potassium salts; or
ix. by weight about 50% of potassium salts; and any one of
x. by weight 20-75% of a milk protein source;
xi. by weight 20-70% of a milk protein source;
xii. by weight 30-70% of a milk protein source;
xiii. by weight 30-60% of a milk protein source;
xiv. by weight 35-60% of a milk protein source;
xv. by weight 40-60% of a milk protein source;
xvi. by weight 45-60% of a milk protein source;
xvii. by weight 45-55% of a milk protein source; or
xviii. by weight about 50% of a milk protein source.

In various embodiments, including any combination of i) to ix) and x) to xviii) above, the emulsifying system comprises less than about 25% by weight sodium emulsifying salts, less than about 20% by weight sodium emulsifying salts, less than about 15% by weight sodium emulsifying salts, less than about 10% by weight sodium emulsifying salts, less than about 5% by weight emulsifying sodium salts, or less than about 1% w/w sodium emulsifying salts.

In one embodiment, the emulsifying salt is a potassium salt, preferably a potassium citrate.

In one exemplary embodiment, the emulsifying salt used as part of the emulsifying system is a citrate salt, for example a potassium citrate, for example tripotassium citrate wherein the emulsifying salt comprises at least 1% by weight of the emulsifying system.

In another aspect, the invention provides an emulsifying system for processed cheese or a processed cheese product, the emulsifying system consisting essentially of, or consisting of milk protein source, for example a milk protein concentrate, and at least one emulsifying salt containing potassium, wherein the at least one emulsifying salt containing potassium comprises at least 10% by weight of the emulsifying system.

In various embodiments the at least one emulsifying salt containing potassium comprises at least about 25% by weight of the emulsifying system, at least about 30% by weight, at least about 35% by weight, at least about 40% by weight, at least about 45% by weight, at least about 50% by weight, at least about 55% by weight, or at least about 60% by weight of the emulsifying system.

In one embodiment, the emulsifying salt containing potassium is a potassium citrate, such as, for example, tripotassium citrate.

In a further aspect the invention relates to a processed cheese or a processed cheese product wherein the processed cheese or cheese product comprises:
(a) by weight 0.1-6% of an emulsifying system; or
(b) by weight 0.1-6% of emulsifying salts;
   wherein the emulsifying system comprises, consists essentially of, or consists of:
i. by weight 10-100% of potassium salts, for example 25-70%; or
ii. by weight 0-100% of sodium salts, for example 25-70%; or
iii. any combination of i) and ii); and
iv. by weight 10-100% one or more milk protein source, for example 25-70%, or wherein the emulsifying salts comprise by weight 10-100% of potassium salts.

In one embodiment, the processed cheese or processed cheese product is a sauce, powder, paste, dip or spread. In another embodiment, the processed cheese or processed cheese product is a ready-made or ready-to-eat food product or meal comprising processed cheese or a processed cheese product such as a sauce, powder, paste, dip or spread. Specifically contemplated examples exemplifying such food products or meals include packaged meals, snacks, and packaged combinations of processed cheese or processed cheese product and crackers, biscuits, cookies, vegetables, or fruit, and the like.

In another embodiment, the processed cheese or processed cheese product is produced by a method of the invention.

In various embodiments, the processed cheese or processed cheese product comprises less than 1% w/w sodium emulsifying salts, less than about 0.9% w/w sodium emulsifying salts, less than about 0.8% w/w sodium emulsifying salts, less than about 0.7% w/w sodium emulsifying salts, less than about 0.6% w/w sodium emulsifying salts, less than about 0.5% w/w sodium emulsifying salts, less than about 0.4% w/w sodium emulsifying salts, less than about 0.3% w/w sodium emulsifying salts, less than about 0.2% w/w sodium emulsifying salts, less than about 0.1% w/w sodium emulsifying salts, or the processed cheese comprises less than about 0.05% w/w sodium emulsifying salts. In one embodiment, the processed cheese comprises no added sodium emulsifying salts.

In various embodiments, the processed cheese or processed cheese product comprises any one of the emulsifying systems presented herein in the Examples. Each emulsifying system is specifically contemplated as if individually recited here.

A “processed cheese” (also known as “process cheese”) is a composition prepared from cheese or ultrafiltration cheese by cooking and melting, with subsequent cooling. It is an emulsion when hot and a suspension when cold, of butter fat droplets in a continuous hydrated protein phase. This is created when natural cheese is subjected to a process of melting and mixing in the presence of processing salts. The processing salts convert the insoluble protein (calcium para-casein) to soluble sodium caseinate through the process of ion exchange, resulting in a stable, continuous phase. When the hot processed cheese is formed, it is a homogeneous pumpable, fluid cheese material that may be formed into sheets, slices or other desired forms. In the prior art, the processing salts are generally emulsifying salts. In embodiments of the present invention, the processing salts include potassium emulsifying salts and milk protein sources functionalised for emulsification. A processed cheese can generally be heated to 70° C., preferably 90° C., to form a melted cheese without separation of liquid free fat.

An “ultrafiltration cheese” is a cheese that has been prepared from ultrafiltered milk that is acidified and heated to produce a cheese. Ultrafiltration cheeses may be made without using coagulation enzymes. They are also known as cheese bases or cheese for manufacture.

An “emulsifying salt” is a salt used in conventional processed cheese manufacture to reduce the tendency for fat globules to coalesce and pool on the surface of the molten cheese. These salts include phosphate salts and salts of organic acids. Examples include but are not limited to sodium and potassium salts that are phosphates, polyphosphates, tartrates or citrates, as well as calcium citrate. Examples of potassium emulsifying salts include potassium citrates such as tripotassium citrate, potassium dihydrogen orthophosphate, dipotassium dihydrogen orthophosphate and dipotassium dihydrogen orthophosphate-3-hydrate and -6-hydrate, dipotassium dihydrogen diphosphate, tripotassium orthophosphate and tripotassium orthophosphate-3-hydrate and -6-hydrate, tetrapotassium diphosphate and tetrapotassium diphosphate-3-hydrate, tetrapotassium pyrophosphate, pentapotassium triphosphate, Kurroll's salt ((KPO₃)ₙ). Sodium emulsifying salts may be selected from the group consisting of one or any mixture of two or more of the following: monosodium phosphate, disodium phosphate, trisodium phosphate, sodium metaphosphate (sodium hexametaphosphate), sodium acid pyrophosphate, tetrasodium pyrophosphate, sodium aluminum phosphate, sodium citrate, sodium tartrate, and sodium potassium tartrate.

In certain embodiments of the present invention, 0.1-100% by weight of the emulsifying salts are selected from either sodium or potassium salts, or a combination thereof. Sodium chloride and potassium chloride are not considered emulsifying salts.

An “emulsifying system” as used herein comprises one or more emulsifying salts, such as those used in conventional processed cheese manufacture, and one or more milk protein sources, including one or more milk protein sources functionalised for emulsification, including one or more milk protein concentrates, to reduce the tendency for fat globules to coalesce and pool on the surface of the molten cheese. In certain examples of the present invention, up to 15% by weight, up to 10%, up to 9%, up to 8%, up to 7%, up to 6%, more commonly 3-6% by weight of the processed cheese comprises the emulsifying system. In further examples of the present invention, from 20% to 70% by weight of the emulsifying system comprises emulsifying salts, such as one or more potassium salts.

It will be appreciated by those skilled in the art that as used herein, the emulsifying system refers to those components added during manufacture of the processed cheese of the invention primarily or specifically for emulsification purposes, and does not contemplate one or more components in the dairy liquid composition or a gelled dairy composition, such as one or more proteins, that may still provide or contribute to emulsification but are present primarily for functions other than emulsification.

A “dairy liquid composition” is any source of milk or milk ingredients useful for cheese manufacture or processed cheese manufacture. In exemplary embodiments, the milk is from sheep, goats, or cows. The composition may have been heat treated to denature the proteins, especially the whey proteins (either on their own or in the presence of casein). Milk concentrates and milk protein concentrates are particularly contemplated dairy liquid compositions for use in this invention.

The dairy liquid composition may comprise casein having a proportion of its divalent ions, including calcium ions, replaced with sodium or potassium ions. Such compositions may be prepared by suspension of a dairy powder from a dairy liquid prepared following replacement of calcium by sodium or potassium. The composition may also be prepared from a blend of such a powder with other ingredients as are known in the dairy processing arts.

The term “milk concentrate” means any liquid or dried dairy-based concentrate comprising milk, skim milk, or milk proteins such that the concentrate has a casein to whey ratio between 1:9 and 9:1 by weight and a casein content above 3% (w/v). A milk protein concentrate is a specifically contemplated milk concentrate for use in the invention.

The term “milk protein source” refers to a milk protein product in which greater than 40%, preferably greater than 55%, most preferably greater than 80% of the solids-not-fat is milk protein (by weight on a moisture-free basis). One example of a milk protein source is a milk protein concentrate.

The term “milk protein concentrate” (MPC) refers to a milk protein product in which greater than 40%, for example greater than 55%, for example greater than 80% of the solids-not-fat (SNF) is milk protein (by weight on a moisture-free basis) and the weight ratio of casein to whey proteins is substantially the same as that of the milk from which it was prepared. Such concentrates are known in the art. MPCs are frequently described with the percentage dry matter as milk protein being appended to “MPC”. For example, MPC70 is an MPC with 70% of the dry matter as milk protein.

A particularly contemplated MPC for use in various embodiments of the present invention is NZMP™ Milk Protein Concentrate 4864. In another embodiment, the MPC is NZMP™ Milk Protein Concentrate 4764.

A “gelled dairy composition” is any dairy liquid composition that has gelled and includes a cheese or an ultrafiltration cheese.

The term “calcium ions” refers broadly to divalent cations and includes ionic calcium and colloidal forms of calcium unless the context requires otherwise.

“Calcium-reduced” or “reduced calcium” ingredients refers to milk compositions and ingredients in which the calcium content is lower than the corresponding non-depleted composition or ingredient.

These ingredients generally have a lower content of divalent cations, such as calcium compared to corresponding non-depleted ingredients. Additionally, the monovalent cation concentrations will be different to that of starting milk.

The term “comprising” as used in this specification means ‘consisting at least in part of’, that is to say when interpreting statements in this specification and claims which include that term, the features, prefaced by that term in each statement, all need to be present but other features can also be present.

The exchange of divalent cations for monovalent cations within native casein micelles in milk or dairy liquid such as milk retentate enhances the ability of the modified casein to emulsify fat. Processing the modified milk or retentate into ingredients for processed cheese manufacture creates ingredients capable of emulsifying milk fat during cooking in a manner that previously required the addition of emulsifying salts. The calcium-reduced milk or dairy liquid may be processed into ingredients for use in the manufacture of processed cheese including specific types of natural cheese, specific cheese for manufacturing, dry milk products, or retentates made by membrane technology. The prepared retentates then are processed into ingredients for the manufacture of processed cheese including natural cheese, cheese for manufacturing, milk protein concentrates, and/or milk protein isolates.

The monovalent cations introduced into milk for exchange with divalent cations in the micelles are typically sodium and potassium ions or both, but other monovalent ions may be included with the sodium and/or potassium, for example, hydrogen ions, H⁺. In one exemplary embodiment, the added monovalent cations replace the divalent cation, calcium, Ca⁺⁺, bound within the casein micelles.

Ion exchange is an exemplary method for exchanging divalent cations in native casein micelles of the prepared milk and/or retentate with monovalent cations. In one embodiment, ion exchange is performed by processing milk and/or retentate with an appropriately charged or activated medium, such as a functionalized gel polymer or resin. These methods include those disclosed in published PCT applications PCT/NZ2000/000247 and PCT/US2000/033521, published as WO01/41579 and WO01/41578, respectively, and US Patent application publication numbers 2003/0096036 and 2004/0197440, hereby incorporated by reference in their entirety. Alternatively, electrodialysis is another exemplary procedure for performing the desired cation exchange in milk. Milk is processed with an appropriate membrane system maintained at an appropriate electrical potential. In another embodiment, electrodialysis and other exemplary membrane procedures are combined with diafiltration. Diafiltration enhances the purity of the casein portion of the retentate. Diafiltration also promotes the desired exchange of divalent cations in the casein micelle with monovalent cations when defined amounts of salt, or sodium chloride, are added to the water.

In a further embodiment, divalent ions are removed using low pH ultrafiltration and/or diafiltration, for example, as described in US patent application publication number 2003/0096036 and PCT application PCT/NZ2000/000247, published as WO 01/41579.

In a further embodiment, the milk or retentate is subjected to proteolysis by a selected proteolytic enzyme or enzymes prior to or after cation exchange. In a specifically contemplated embodiment, milk or retentate is treated with chymosin (EC 3.4.23.1) or by a similar cheese coagulating enzyme following the cation ion exchange and the removal of the divalent cations, particularly ionic calcium. Chymosin, or rennet, cuts [symbol] -casein at or near amino acid residues Phe₁₀₅-Met₁₀₆ to create para [symbol] -casein and glycomacropeptide as the first stage in milk coagulation for cheese manufacture.

The emulsifying salts used may be mixed with the liquid dairy ingredient or a gelled dairy ingredient or a mixture of more than one ingredient. They may also be added to the mixture during or after heating, but should be added before formation (setting) of the final product.

Previously, the exclusive use of potassium salts as emulsifying salts (i.e., without the addition of sodium salts) resulted in undesirable flavour characteristics in the processed cheese product. Likewise, processed cheese having a significant proportion of the emulsifying salt as potassium salts (even in the presence of sodium salts) typically possesses more undesirable flavour characteristics than those with lower proportions of potassium salts. Consequently, sodium salts have typically been required to achieve adequate emulsifying activity, while retaining desirable flavours or avoiding undesirable flavours associated with high potassium salt content.

In certain embodiments, the process of the invention uses only emulsifying salts comprising potassium, and emulsifying salts comprising sodium are not included. In one exemplary embodiment, an emulsifying system comprising a mixture of MPC and tripotassium citrate is used. In one embodiment the use of an emulsifying system consisting essentially of, or consisting of a mixture of milk protein source, for example MPC, and tripotassium citrate is provided. In another embodiment the use of an emulsifying system consisting essentially of, or consisting of a mixture of milk protein source, for example MPC, and trisodium citrate is provided. Preferably, the content of emulsifying system in the heated mixture is 0.5-4.0% (w/w) with 0.1-2.9% (w/w) being emulsifying salts comprising potassium. In one embodiment, the content of emulsifying system in the heated mixture is 3.0-5.5% (w/w) of the formulation with 0.1-2.9% (w/w) of the formulation being emulsifying salts comprising potassium.

In a preferred embodiment, the emulsifying salts comprise 0.5-2.8% (w/w final product). For example, the emulsifying salt is tripotassium citrate, including tripotassium citrate, at about 2% to about 97% of the emulsifying system, about 25% to about 70% of the emulsifying system, preferably from about 30% to about 65%, from about 35% to about 60%, from about 40% to about 55%, from about 45% to about 55%, or preferably about 50% of the emulsifying system.

The use of calcium-reduced MPCs reduces the calcium content of the cheese. If this reduction is considered undesirable, calcium, such as substantially insoluble calcium, can be added to bring the calcium level to that desired in the cheese product.

It will be appreciated that the appropriate cooking conditions vary considerably and are a function of the type of processed cheese being manufactured. The cooking conditions for processed cheeses of the invention do not differ significantly from the manufacture of traditional or non-sodium reduced processed cheese. For example, temperatures from 65° C.-150° C. are preferred. Shorter cooking times are preferred for higher temperatures. Thus at 65° C.-110° C. cooking times of 1-30 minutes are preferred, with 1-10 minutes more preferred and 2-5 minutes most preferred. With cooking at 130° C.-150° C., the preferred cooking time is 0.1-50 seconds, with 10-30 seconds more preferred and 15-25 seconds most preferred. At 110° C.-130° C., 10 seconds-5 minutes cooking is preferred. At the end of the cooking step the composition is an emulsion. This contrasts with the situation where cheese is cooked without the calcium-depletion of a casein source or without sufficient emulsification where separation out of fat occurs.

Cooling conditions may also vary considerably and are a function of the type of processed cheese being manufactured. Again, the cooling conditions do not differ significantly from the manufacture of traditional or non-sodium reduced processed cheese. For example, for applications such as sliced processed cheese (whether slice on slice (SOS) or individually wrapped slice (IWS)), the cooked mixture may be cooled to about 4° C. to 6° C. in 1-2 minutes. For other applications, such as preparation of block processed cheese, cooling may be to the local ambient temperature, taking place over days.

Typically, the final product pH, and cooling temperature is exactly controlled to produce the desired melting ability, body, and texture of the finished processed cheese or related product. Generally the final product pH is in the range 4.6-6.4, preferably 5.0-6.0, more preferably 5.4-5.9. These pH ranges are also preferred for the compositions to be cooked in other embodiments of the invention.

Other ingredients may be used in the processed cheese. These may be selected from those allowed for the manufacture of processed cheese currently selected from one or more of:
acidifying agents consisting of one of or any mixture of the following: vinegar, lactic acid, citric acid, acetic acid, and phosphoric acid;
cream, anhydrous milkfat, dehydrated cream, or any combination of two or more of these;
water, salt, permitted artificial colouring, spices or flavourings;
milk, skim milk, buttermilk, cheese whey, any of the foregoing from which part of the water has been removed, albumin from cheese, cheese whey or other dairy solids;
acidifying agents; and
preservatives including sorbic acid, potassium sorbate, and/or sodium sorbate.

Also envisaged are ingredients selected from those additionally allowed in the manufacture of various processed cheese types including those described in 21 CFR 133 Cheese and Related Cheese Products, as well as those described in Codex (Codex Alimentarius, 2010).

Other ingredients, such as those recited above, may be used where these are acceptable to the local jurisdiction or regulatory authorities. Further envisaged are gums, for example, carob bean, karaya, tragacanth, guar, gelatine, and sweetening agents, for example, sugar, dextrose, corn sugar, corn syrup, corn syrup solids, glucose, syrup, glucose syrup solids, maltose, malt syrup, and hydrolyzed lactose, and fortifying agents, for example calcium, iron and other minerals, and other fat or oil sources such as vegetable oil, and dry milk, whey and whey protein concentrate and non-dairy protein sources where appropriate. Nisin may also be included.

An important feature of the process is to replace a substantial amount of the sodium typically used in processed cheese manufacture, without affecting emulsification, flavour, food safety attributes or functionality, such as by imparting undesirable flavours typically associated with potassium salts. For example, the emulsifying system of the invention maintains or enhances the functional properties of the finished processed cheese or related product.

By reducing the use of sodium emulsifying salts through the use of the emulsifying system of the present invention, the sodium content of the product is reduced without adversely affecting flavour, such as by imparting undesirable flavours typically associated with potassium salts. Additionally, the emulsifying system of the invention maintains or enhances the nutritional and functional properties of the finished processed cheese or related product.

The invention also provides a processed cheese prepared by a method of the invention.

In a preferred embodiment, the processed cheese is prepared in a method comprising:
(a) providing a mixture comprising cheese, milk protein concentrate, a milkfat source, at least one emulsifying salt, and water;
(b) cooking the mixture to between 65° C.-150° C. to obtain a smooth emulsion;
(c) cooling the cooked mixture to obtain a processed cheese
   wherein the milk protein concentrate has been treated with cation exchange chromatography to replace 20-80% of its calcium by sodium or potassium ions and has a dry matter content that is 10-30% of the weight of cheese, and wherein the emulsifying salts comprise by weight 10-100% of potassium salts.

The present invention thus provides a reduced sodium processed cheese having one or more functional properties, organoleptic profiles, and food safety attributes comparable to processed cheeses having conventional levels of sodium. As used herein, a processed cheese having desirable food safety attributes means that the product inhibits or discourages the growth of bacteria (particularly contaminating pathogens) and/or supports or promotes bacterial inactivation. This is an important issue for the food industry, including food processors, food service operators, and food retailers. It is also important for federal, state and local food safety regulators, public health officials, food testing laboratories and process authorities.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### EXAMPLES

The following non-limiting example further illustrates practice of the invention.

### Example One

This example describes the development and manufacturing of reduced sodium processed cheeses and related products with selected combinations of emulsifying salts and MPC, together with a comparison to normal sodium processed cheese foods produced from standard formulations as follows:
Control products made with emulsifying salts using typical manufacturing techniques for processed cheese (Control 1 & 2);
Reduced sodium products made with various combinations of emulsifying salts and milk protein sources functionalised for emulsification (representative formulations A, B, D, and E, and specific samples as numbered).

The formulations for representative processed cheese products are shown in Table 1.

TABLE 1
Formulations

| | Formu- | Formu- | Formu- | Formu- | Formu- |
|---|---|---|---|---|---|
| | lation A | lation B | lation C | lation D | lation E |
| Formulation | 20% Na | 40% Na | Control 2 | 20% Na | 20% Na |
| | reduced | reduced | | reduced | reduced |
| Ingredient | Quantity | Quantity | Quantity | Quantity | Quantity |
| Type | | | | | |
| Cheese + | 76.1% | 76.0% | 76.0% | 73.3% | 73.4% |
| Milk fat | | | | | |
| Dairy Solids | 3.4% | 4.5% | 3.4% | 6.3% | 7.0% |
| including | | | | | |
| Functional | | | | | |
| Dairy Solids | | | | | |
| TSC | 2.3% | 0.5% | 3.8% | 1.4% | 1.8% |
| TPC | 1.6% | 2.0% | 0.0% | 1.1% | 0.0% |
| Salt | 0.7% | 0.9% | 1.0% | 1.1% | 0.9% |
| Flavour and | 1.0% | 1.0% | 1.0% | 0.5% | 0.5% |
| Preservatives | | | | | |
| Water | 15.1% | 15.1% | 15.0% | 16.4% | 16.4% |
| TOTAL | 100.0% | 100.0% | 100.0% | 100.0% | 100.0% |

Tables 2 and 3 below show the total emulsifying system (TES) for each formulated product composition.

TABLE 2
Composition of total emulsifying system of processed cheese

| Sample | | MPC¹ | TPC² | TSC³ | NaCl | TES⁴ |
|---|---|---|---|---|---|---|
| # | Formulation | g/20 kg | g/20 kg | g/20 kg | g/20 kg | % |
| 99 | Control 1 | 0 | 0 | 730 | 220 | 4 |
| 185 | Control 2 | 0 | 0 | 750 | 200 | 3.8 |
| 148 | MPC | 200 | 260 | 270 | 200 | 3.7 |
| 219 | MPC | 410 | 230 | 130 | 150 | 3.9 |
| 218 | MPC | 320 | 320 | 140 | 150 | 3.9 |
| 216 | MPC | 170 | 470 | 150 | 150 | 4.0 |
| 100 | MPC | 660 | 240 | 50 | 170 | 4.8 |
| 122 | MPC | 480 | 240 | 50 | 180 | 3.9 |
| 212 | MPC | 300 | 410 | 70 | 200 | 3.9 |
| 182 | MPC | 290 | 321 | 50 | 200 | 3.3 |
| 213 | MPC | 440 | 330 | 50 | 200 | 4.1 |
| 211 | MPC | 240 | 480 | 70 | 200 | 4.0 |
| 192 | MPC | 350 | 390 | 50 | 200 | 4.0 |
| 221 | No MPC | 0 | 321 | 430 | 150 | 4.5 |

¹NZMP ™ Milk Protein Concentrate 4864 (Fonterra Co-operative Group, Ltd., Auckland, New Zealand).
²TPC is Tri-potassium citrate monohydrate.
³TSC is Tri-sodium citrate dihydrate.
⁴TES = Total Emulsifying System = MPC + TPC + TSC.

TABLE 3
Composition of total emulsifying system of processed cheese

| Sample # | Formulation | TES¹ g/20 kg | TPC/TES % |
|---|---|---|---|
| 99 | Control 1 | 730 | 0 |
| 185 | Control 2 | 750 | 0 |
| 148 | MPC | 730 | 36 |
| 219 | MPC | 770 | 30 |
| 218 | MPC | 780 | 41 |
| 216 | MPC | 790 | 59 |
| 100 | MPC | 950 | 25 |
| 122 | MPC | 770 | 31 |
| 212 | MPC | 780 | 53 |
| 182 | MPC | 661 | 49 |
| 213 | MPC | 820 | 40 |
| 211 | MPC | 790 | 61 |
| 192 | MPC | 790 | 49 |
| 221 | No MPC | 751 | 43 |

¹TES = MPC + TPC + TSC.

NZMP™ Milk Protein Concentrate 4864 (Fonterra Co-operative Group, Ltd., Auckland, New Zealand) is a commercially available calcium reduced product, typically containing 81.5% protein, 5.8% moisture, 3.5% fat, 1700 mg/100 g sodium, and 800 mg/100 g calcium. A representative comparative milk protein concentrate, NZMP™ Milk Protein Concentrate 485 (Fonterra Co-operative Group, Ltd.) contains 81.3% protein, 5.7% moisture, 1.6% fat, 70 mg/100 g sodium, and 2230 mg/100 g calcium.

A representative outline of the trial manufacturing procedure for Slice-on-Slice (SOS) processed cheese manufacture used in this example is as follows:

The processed cheese was made in a solid screw processed cheese cooker (Blentech, Rohnert Park, Calif.) with a 20 kg batch size. The cheese and butter were ground with a Reitz grinder and then weighed into one container. All other ingredients were weighed in separate containers. All ingredients were blended until a homogenous mass was produced. The pH was then measured, and citric acid was added to give pH of 5.70.

Condensate was bled from the Blentech steam line before cooking. The same cooking process was used to prepare all formulations. The ingredients were cooked to a temperature of 88° C. by direct steam injection, the formulation allowing for the added water as steam condensate. The controlled temperature increase allowed a cooking time of 5 minutes with the auger speed set to 120 rpm. On reaching 88° C., steam addition was stopped and blending speed was increased to 150 rpm, until 7 minutes of total cooking time was completed.

The cooked mixture was transferred using a pump into a filling container and then into a cold table hopper. The processed cheese was then cast as slices on a cold table covered with a plastic sheet and fitted with a 2 mm frame, using the cold table hopper and a spreading knife Slices were cut with approximate dimensions of 76×76 mm, and a thickness of 2 mm Slices were wrapped and packed and labelled.

Additionally, separate portions of processed cheese were poured into butter containers in the shape of loaves for chemical and microbial analysis. All loaves and slices were cooled and held at refrigeration temperatures ≦5° C. until analysis.

Table 4 below shows the finished product composition of the formulations as determined by analysis.

TABLE 4
Composition of processed cheese determined by analysis

| Sample | | Moisture | Fat | Protein | K | Na |
|---|---|---|---|---|---|---|
| # | Formulation | (%)¹ | %¹ | % | mg/kg | mg/kg |
| 99 | Control 1 | 42.3 | 28.7 | 23.0 | 1060 | 17400 |
| 185 | Control 2 | 41.5 | 28.5 | 19.8 | 1450 | 17800 |
| 148 | MPC | 41.7 | 30.1 | 22.2 | 5570 | 11900 |
| 219 | MPC | 42.1 | 28.2 | 19.9 | 5570 | 9410 |
| 218 | MPC | 42.6 | 28.1 | 19.8 | 6530 | 9310 |
| 216 | MPC | 42.0 | 28.4 | 19.7 | 8670 | 9700 |
| 100 | MPC | 41.2 | 29.8 | 23.1 | 5340 | 9600 |
| 122 | MPC | 42.0 | 29.9 | 22.8 | 5630 | 9460 |
| 212 | MPC | 41.1 | 28.8 | 20.0 | 8390 | 9790 |
| 182 | MPC | 42.3 | 28.9 | 19.6 | 7390 | 9820 |
| 213 | MPC | 41.6 | 29.1 | 20.0 | 7180 | 9600 |
| 211 | MPC | 41.4 | 28.5 | 20.4 | 9220 | 10100 |
| 192 | MPC | 42.6 | 27.2 | 20.7 | 8380 | 10000 |
| 221 | No MPC | 41.0 | 28.3 | 19.1 | 6380 | 14100 |

All products made with added NZMP™ 4864 maintained similar compositions, fully meeting the moisture and fat requirements listed in Codex. The appearance of each of these products at the completion of cooking greatly resembled similarly cooked, high quality normal sodium processed cheese made with added NaCl and emulsifying salts. No free fat was observed on any product made with added NZMP™ 4864.

Cooked product from all the formulations containing NZMP™ 4864 readily gelled within 30 seconds to 1 minute after being spread upon the casting table. The gelled products made with NZMP™ 4864 all readily cut cleanly to form highly acceptable slices. These were readily removed from the table and packaged in film without losing the desired shape or sticking to either the table or film surfaces.

The viscosity of all samples was consistent with the processability typical of processed cheese. Table 5 shows the melting ability and firmness of the processed cheese formulations produced as described above. The ability of the samples to melt was measured by the Schreiber test (Zehren, V. L., and D. D. Nusbaum. 1992. Process Cheese. Cheese Reporter Publishing Co., Inc. Madison, Wis. Pp. 294-295.), For IWS evaluations, an adapted Schreiber test was used, modified to test at lower temperatures and longer duration. Samples for firmness and vane testing were prepared by stacking slices to a height of 25 mm. Firmness was measured at 13° C. using a using a Stable Micro Systems Texture Analyser TA-HD. A 6 mm stainless steel cylindrical probe was inserted into the sample stack at 1 mm/s to a depth of 10 mm. The maximum force was recorded as the firmness. Stress and strain were measured at 13° C. using a Brookfield 5×HBTDV-II. A 4-bladed vane (6 mm width) was inserted into the sample stack to depth of 15 mm and then rotated at 0.5 rpm until the yield point was reached. The torque and time data at the yield point were then converted to stress and strain

TABLE 5
Meltability and firmness of processed cheese

| | | Firmness¹ | Stress | Strain | Schreiber |
|---|---|---|---|---|---|
| Sample # | Formulation | (N) | (KPa) | (—) | Melt Score² |
| 99 | Control 1 | 10.39 | 26.2 | 0.67 | 7.39 |
| 185 | Control 2 | 8.03 | 19.8 | 0.72 | 6.56 |
| 148 | MPC | 9.31 | 24.1 | 0.60 | 5.28 |
| 219 | MPC | 7.46 | 17.3 | 0.67 | 6.28 |
| 218 | MPC | 7.16 | 16.9 | 0.70 | 6.83 |
| 216 | MPC | 7.32 | 18.0 | 0.67 | 6.39 |
| 100 | MPC | 11.45 | 29.0 | 0.65 | 6.39 |
| 122 | MPC | 9.79 | 24.7 | 0.66 | 6.72 |
| 212 | MPC | 7.82 | 20.2 | 0.66 | 5.89 |
| 182 | MPC | 10.33 | 24.7 | 0.67 | 7.11 |
| 213 | MPC | 7.96 | 18.8 | 0.66 | 6.72 |
| 211 | MPC | 7.92 | 20.7 | 0.67 | 6.89 |
| 192 | MPC | 7.11 | 15.9 | 0.75 | 6.50 |
| 221 | No MPC | 10.50 | 28.4 | 0.65 | 6.30 |

¹Firmness data based upon analysis of 5 separate measurements from each formulation.
²Most commercial applications require processed cheese with a Schreiber melting ability of >3-4.

The melting ability of the slices made by all the treatments met the typical minimal melting requirements of the Schreiber test used here. The average firmness of the various cheeses produced was moderately variable, but the range of firmness measurements of the reduced sodium processed cheese was generally comparable to control, normal sodium processed cheese.

The sodium content of the products produced using the various combinations of MPC and emulsifying salts of the invention was much lower than observed in typical, normal sodium control products (i.e., from 9310 to 11900 mg/Kg, compared to 17100 to 18700 mg/Kg).

Trained cheese graders determined that the flavour of certain samples of the reduced sodium processed cheese slices made with combinations of MPC and emulsifying salts closely resembled that of processed cheese with normal sodium levels. Table 6 below presents the results of sensory evaluation of representative cheeses produced herein.

TABLE 6
Sensory evaluation of processed cheese

| Sample # | Formulation | pH | Sensory preferences/evaluation |
|---|---|---|---|
| 99 | Control 1 | 5.62 | Typical flavour |
| 185 | Control 2 | 5.68 | Typical flavour |
| 148 | MPC | 5.55 | Close to typical flavour |
| 219 | MPC | 5.45 | more acidic, otherwise similar to |
| | | | control, preferred sample |
| 218 | MPC | 5.45 | weak butyric note, similar saltiness to |
| | | | control |
| 216 | MPC | 5.53 | cheesy, sour, more savoury, less salty |
| 100 | MPC | 5.51 | Close to typical flavour |
| 122 | MPC | 5.50 | Close to typical flavour |
| 212 | MPC | 5.51 | more savoury, better break, close to |
| | | | typical flavour |
| 182 | MPC | 5.60 | Close to typical flavour |
| 213 | MPC | 5.54 | bland, aftertaste, softer |
| 211 | MPC | 5.59 | acid, bitter, astringent, |
| 192 | MPC | 5.63 | Close to typical flavour |
| 221 | No MPC | 5.73 | Close to typical flavour |

In certain samples, including those from preliminary trials, undesirable flavours associated with sodium substitute salts, such as metallic/bitter/chemical flavours associated with tripotassium citrate, were identified. The results of the sensory evaluations of representative reduced sodium formulations of the invention support the applicants' view that the use of particular combinations of MPC and emulsifying salts in the manufacture of processed cheese are able to provide low sodium processed cheese with flavour profiles comparable to normal sodium processed cheese, and/or are able to greatly reduce or prevent the associated flavours these sodium substitute compounds impart to the finished product, even in the presence of high concentrations of such compounds or when such compounds are present as the major component of the total emulsifying system.

Production of processed cheese with various combinations of MPC (NZMP™ 4864) and emulsifying salts produced acceptable products with a sodium content much lower than that of control products produced with typical emulsifying systems. The results of this experiment therefore demonstrate the production of reduced sodium processed cheese-type products with unique combinations of ingredients without incurring a reduction in desirable characteristics—whether functional or sensory—in the finished product.

### Example Two

### Introduction

This example describes the larger-scale trial manufacture of three slice-on-slice (SOS) processed cheese formulations: a 20% sodium reduced processed cheese (A) based on sample 221, a 40% sodium reduced processed cheese of the present invention (B, based on sample 192 as described above in Example 1), and a control processed cheese having normal sodium content (C, based on sample 185 as described above in Example 1).

Samples A, B and C passed standard commercial grading for functionality, organoleptic and microbial attributes.

A representative outline of the large scale trial manufacturing procedure for Slice-on-Slice (SOS) processed cheese used in this example is as follows:

All cheese and milkfat were size reduced before introduction into a blender where they were mixed with all other ingredients excluding water from steam condensate. Moisture and pH were corrected as required after thorough mixing.

The blended material was then passed through a direct steam injected continuous cooker operating at a speed of 600-1000 rpm where the cheese material reached a temperature of 87-96° C.

The molten cheese material was then formed and cooled to 8-10° C. and cut using traditional slice-on-slice forming equipment to give slices of approximately 78 mm×78 mm. The slices were stacked to form loaves of 160 slices which were packaged in a modified atmosphere.

Manufacture of processed cheese by formulations A and B produced a well emulsified, smooth product. The total emulsifying system in formulations A & B created the desired casein gel upon cooling, producing a finished processed cheese with the desired body and texture, comparable to that of the normal sodium cheese produced by formulation C. The cooked product readily gelled within 30 seconds to 1 minute upon cooling. The gelled product cut cleanly to form highly acceptable slices that were readily removed and packaged without losing the desired shape or sticking to cutting surfaces. The finished product at the completion of cooking greatly resembled similarly cooked, high quality normal sodium processed cheese made with trisodium citrate salts, such as those produced by formulation C.

The moisture, fat, and general composition of all products comply with the Codex general standard. The calcium content of the processed cheese made with formula A or with formula B was comparable to that of normal sodium processed cheese.

The sodium content of the processed cheese made with formula A was lower, and that of the processed cheese of formula B was markedly lower, than that of the control processed cheeses made with formula C.

Processed cheese made with the emulsifying system in formula B produced highly acceptable products with a markedly reduced sodium content compared to the control formulation, while retaining characteristics including calcium content comparable to those of the typical, normal sodium product. Furthermore, processed cheese made with the emulsifying system in formula A also produced highly acceptable products with a reduced sodium content compared to the control formulation, again while retaining characteristics including calcium content comparable to those of the typical, normal sodium product. The results therefore demonstrate the production of processed cheese-type products having beneficial nutritional profiles (for example, greatly reduced sodium yet equivalent calcium) compared to that of the typical product.

### Example Three

### Introduction

This example describes microbial challenge trials of two slice-on-slice (SOS) reduced sodium processed cheese formulations of the present invention and a control SOS processed cheese having normal sodium content.

### Methods

Three slice-on-slice (SOS) processed cheese formulations were assessed: a 20% sodium reduced processed cheese (A), a 40% sodium reduced processed cheese of the present invention (B, as described above in Example 2), and a control processed cheese having normal sodium content (C, as described above in Example 2). The composition is described in Table 1.1 and compositional characteristics important to food safety of each SOS formulation are shown below in Table 3.3.

SOS samples were tested in duplicate to evaluate their ability to inhibit or support growth of several food-borne pathogens during out-of-refrigeration storage. Cheese slices were inoculated with Listeria monocytogenes, Staphylococcus aureus, Salmonella, and E. coli strains as shown below, stored at 30° C. and tested at T0 and every 24 hours for 4 days, using established food safety protocols. Un-inoculated duplicates of each SOS sample were also stored at 30° C. and tested at T0 and every 24 hours for 4 days to establish background microflora (APC).

Samples inoculated with E. coli were tested on both selective (VRBGA) and non-selective (MPCA) agar. E. coli grown on selective agar are stressed and are not recovered well, and so selective agar may over estimate E. coli die-off. Conversely, background microflora other than E. coli are able to grow on non-selective agar, and so care must be taken when interpreting these results as they may over-represent susceptibility to E. coli challenge.

### Results and Discussion

### Un-Inoculated Samples

The microbiological results for the un-inoculated samples are summarised in Table 7 below.

TABLE 7
Microbiological results of un-inoculated control samples

| | | | | | | | Sulphite-reducing | | | | | | | | |
|---|---|---|---|---|---|---|---|---|---|---|---|---|---|---|---|
| | APC | | | Meso Spores | | | Clostridia | | | Coliforms | | | B. cereus | | |
| | MPCA | | | MPCA + starch | | | DRCA 80° C. 10 min, | | | VRBGA | | | MYP | | |
| | 30° C./72 h | | | 30° C./48 h | | | 30° C./72 h anaerobic | | | 30° C./24 h | | | 30° C./48 h | | |
| | Log CFU/g | | | Log CFU/g | | | Log CFU/g | | | Log CFU/g | | | Log CFU/g | | |
| Days | A | B | C | A | B | C | A | B | C | A | B | C | A | B | C |
| 0 | 2.11 | 2.35 | 2.13 | | | | | | | <1.0 | <1.0 | <1.0 | 1.00 | 1.00 | <1.0 |
| 1 | 1.80 | 1.78 | 1.70 | 1.75 | 1.75 | 1.75 | <1.0 | <1.0 | <1.0 | <1.0 | <1.0 | <1.0 | | | |
| 2 | 2.08 | 2.30 | 2.50 | | | | | | | | | | | | |
| 3 | 1.95 | 1.69 | 1.78 | 1.30 | 1.54 | 1.81 | <1.0 | <1.0 | <1.0 | | | | <2.0 | <2.0 | <2.0 |
| 4 | 2.04 | 1.85 | 1.85 | | | | | | | | | | | | |

### Inoculated Samples

The microbiological challenge results for the inoculated samples are summarised in Table 8 below. The inoculated formulation A and formulation B performed favourably compared to the normal sodium control formulation, formulation C.

TABLE 8
Microbiological results of inoculated (challenged) samples

| | E. coli¹ | | | E. coli | | | S. aureus² | | | Listeria³ | | | Salmonella⁴ | | |
|---|---|---|---|---|---|---|---|---|---|---|---|---|---|---|---|
| | VRBG | | | MPCA | | | BPA | | | PALCAM | | | XLD | | |
| | 30° C./24 h | | | 30° C./72 h | | | 37° C./48 h | | | 37° C./48 h | | | 30° C./48 h | | |
| | Log CFU/g | | | Log CFU/g | | | Log CFU/g | | | Log CFU/g | | | Log CFU/g | | |
| Days | A | B | C | A | B | C | A | B | C | A | B | C | A | B | C |
| 0 | 3.38 | 3.27 | 2.45 | 3.57 | 3.50 | 2.71 | 3.58 | 3.57 | 3.66 | 3.58 | 4.15 | 3.59 | 3.18 | 3.08 | 3.15 |
| 1 | <1.0 | 1.87 | 1.00 | 3.08 | 2.63 | 1.84 | 3.51 | 3.2 | 3.62 | 3.17 | 3.41 | 3.49 | 3.17 | 2.48 | 1.77 |
| 2 | 2.22 | 1.45 | <1.0 | 3.85 | 2.37 | 1.92 | 3.88 | 3.2 | 4.81 | 3.04 | 3.18 | 3.31 | 2.16 | 1.69 | 1.15 |
| 3 | 1.78 | 1.32 | <1.0 | 2.21 | 1.89 | 2.40 | 5.95 | 2.98 | 6.66 | 2.95 | 3.13 | 3.41 | 1.84 | 1.63 | 1.15 |
| 4 | 1.94 | 1.33 | <1.0 | 2.42 | 3.46 | 1.50 | 7.26 | 2.95 | 7.40 | 2.71 | 3.00 | 3.27 | 1.97 | 1.63 | 1.30 |

¹E. coli strains used in challenge = E9, E19, 3614
²S. aureus strains used in challenge = S100, S12, NZRM 103
³L. monocytogenes strains used in challenge = ATCC19111, 4238, 4230
⁴Salmonella strains used in challenge = S. typhimurium NZRM 4220, S. heidelburg NZRM 4212, S. enteritidis NZRM 4201

As can be seen in Table 8, E. coli did not grow in any of the 3 formulations challenged. E. coli was inoculated onto the samples at approximately 3 log CFU/g, and the population present on each formulation declined during the trial.

Staphylococcus aureus grew in the control formulation C, and formulation A, but did not grow on formulation B. S. aureus was inoculated onto the samples at counts of approx. 3.6 log CFU/g. In the control formulation C, significant growth (≧1 log increase) was observed at 72 hours. A similar growth trend was observed in the sample A formulation, although the growth was delayed by a further 24 hours compared with the control formulation C. No growth was observed in the sample B formulation, even at 96 hours.

Listeria monocytogenes was not able to grow in any of the 3 formulations challenged. L. monocytogenes was inoculated onto the samples at counts of 3.6-4.15 log CFU/g, and the population on each sample declined slightly during the trial.

Salmonella was also not able to grow in any of the 3 formulations challenged. Salmonella was inoculated onto the samples at counts of 3.1-3.18 log CFU/g and counts declined in all 3 formulations during the trial.

Table 9 below presents representative compositional characteristics of the three formulations that are believed to be important to food safety. The descriptor S/(M+S) refers to the sodium chloride level divided by the sum of the sodium chloride level and moisture. This is one indicator of the likely preservative effect, as recognised in the art, where a lower number indicates a lower likely preservative effect. Another indicator of preservative effect is the pH, where a lower pH typically has a better preservative effect. Of the 3 formulations tested, the 20% reduced sodium formulation A had the lowest S/(M+S) of 4.12 and the lowest pH at 5.61. The 40% reduced sodium formulation B had a S/(M+S) of 4.65 and pH 5.75. The normal sodium control formulation C had a S/(M+S) of 4.73 and pH of 5.67.

TABLE 9
Formulation parameters of importance to food safety

| | | | | | Water |
|---|---|---|---|---|---|
| Formulation | % NaCl | % Moisture | (S/(M + S)) * 100 | pH | Activity |
| A | 1.76 | 43.0 | 3.93 | 5.74 | 0.95 |
| B | 2.05 | 43.0 | 4.55 | 5.61 | 0.96 |
| C | 2.14 | 42.9 | 4.75 | 5.64 | 0.95 |

The water activity (Aw) levels are also considered influential in effecting bacteriological growth. The water activity of all samples did not differ significantly.

Importantly, the processed cheese produced by formulation B (Sample 192) was considered to be as food safe as that of the normal sodium control formulation, formulation C. Indeed, a shelf life of formulation B comparable to that of non sodium reduced reference samples may be extrapolated based on the above microbial challenge results.

### Example 4

### Introduction

This example describes the manufacture of exemplary processed cheeses, each targeting an approximately 40% sodium reduction, using a variety of formulations, and their comparison to a control (normal sodium) cheese.

Table 10 below summarises the emulsifying system prepared to target a 40% reduction in sodium used for each formulation, together with the percentage sodium reduction achieved.

TABLE 10
Formulations

| | % Na | |
|---|---|---|
| Sample # | reduction | Description |
| 123 | 0 | Control (normal sodium) |
| 268 | 41 | Sodium reduction achieved using sodium and |
| | | potassium emulsifying salts and functional MPC. |
| 195 | 36 | Sodium reduction achieved using potassium |
| | | emulsifiers. |
| 370 | 32 | Sodium reduction achieved by reducing |
| | | total emulsifying salts. |
| 373 | 45 | Sodium reduction achieved using a combination |
| | | of potassium emulsifying salts and MPC. |
| 371 | 42 | Sodium reduction achieved using a combination |
| | | of functional MPC and reduced level of |
| | | emulsifying salts. |
| 267 | 42 | Sodium reduction achieved using a combination |
| | | of sodium and potassium emulsifying salts and |
| | | an alternative functional MPC. |

Table 11 below shows the composition of the total emulsifying system (TES) for each exemplary cheese formulation prepared in this example. Notably, the range of TES percentage (expressed as w/w in the final cheese product) in the various exemplary cheeses was representative of the range of levels of emulsifiers typically employed in the manufacture of normal sodium processed cheeses, except for sample 370, in which the targeted sodium reduction was achieved by a reduction of the amount of emulsifying salts present.

TABLE 11
Composition of total emulsifying system of processed cheese

| | MPC | TPC | TSC | NaCl | TES |
|---|---|---|---|---|---|
| Sample # | (g/20 kg) | (g/20 kg) | (g/20 kg) | (g/20 kg) | (% w/w) |
| 123 | 0 | 0 | 720 | 190 | 3.6 |
| 268 | 350 | 390 | 50 | 190 | 3.95 |
| 195 | 0 | 630 | 150 | 150 | 3.9 |
| 370 | 0 | 0 | 240 | 190 | 1.2 |
| 373 | 350* | 240 | 0 | 190 | 2.95 |
| 371 | 350 | 240 | 0 | 190 | 2.95 |
| 267 | 400 | 390 | 50 | 190 | 4.2 |

*NZMP ™ Milk Protein Concentrate 4850

As can be seen in Tables 12 to 13 below, the exemplary cheeses prepared in this example were compositionally similar, as evidenced by, for example, moisture content.

TABLE 12
Composition Summary

| | Moisture | | | | |
|---|---|---|---|---|---|
| Sample # | (%) | Fat (%) | Protein (%) | K (mg/kg) | Na (mg/kg) |
| 123 | 41.1 | 30 | 19.7 | 1140 | 18700 |
| 268 | 41.2 | 29.9 | 20.5 | 8070 | 10100 |
| 195 | 41.3 | 28.4 | 19.6 | 12200 | 10800 |
| 370 | 41.3 | 30.7 | 20.3 | 1670 | 12100 |
| 373 | 41.2 | 30.5 | 20.5 | 6040 | 9330 |
| 371 | 41.8 | 30.6 | 20.4 | 5610 | 9540 |
| 267 | 41.0 | 30.5 | 20.5 | 7550 | 9910 |

As shown in Table 12 above, the moisture, fat, and general composition of all products complies with the Codex general standard. Protein composition was comparable across all seven cheeses.

TABLE 13
Functional & Sensory Summary

| Sample # | Firmness (N) | Schreiber Melt Score |
|---|---|---|
| 123 | 10.7 | 6.7 |
| 268 | 11.1 | 6.2 |
| 195 | 10.6 | 6.2 |
| 370 | 9.5 | 6.4 |
| 373 | 8.9 | 6.1 |
| 371 | 9.6 | 6.1 |
| 267 | 11.2 | 5.8 |

Table 13 shows the melting ability and firmness of the processed cheeses produced in this example. The ability of samples to melt was measured by the Schreiber test (see Example One), and firmness was measured as described in Example One above. The melting ability of the slices made by all the treatments met the typical minimal melting requirements of the modified Schreiber test used here. The added firmness of the various cheeses varied moderately, but with the exception of sample 373, the firmness measurements of reduced sodium processed cheese prepared in this example was generally comparable to control, normal sodium processed cheese (sample 123). Sample 373 was made using NZMP MPC 4850 and had a soft pasty texture along with poor sensory characteristics. This exemplifies the role that functional MPCs contribute to the invention in achieving desirable product characteristics.

As will be appreciated, it is possible to make sodium reduced process cheese in a number of ways. However, many of these methods will result in cheeses that exhibit defects in either functionality or sensory properties. This example shows that high quality, desirable processed cheeses made with 40% less sodium than conventional process cheese were made using a total emulsifying system comprising emulsifying salts and functional MPC (see, for example, samples 268 and 371 above).

### Example Five

### Introduction

This example demonstrates that the technology developed to manufacture slice on slice reduced sodium processed cheese can be applied to other formats, including individually-wrapped slices (IWS), and spreads.

TABLE 14
Formulations

| Sample # | % Na reduction | Description |
|---|---|---|
| 300 | 0 | Control IWS |
| 293 | 35 | IWS formulation with sodium reduction |
| | | achieved using sodium and potassium |
| | | emulsifying salts and functional MPC. |
| 367 | 0 | Control Spread |
| 366 | 43 | Spread formulation with sodium reduction |
| | | achieved using sodium and potassium |
| | | emulsifying salts and functional MPC. |
| 368 | 20 | Spread formulation with sodium reduction |
| | | (20%) achieved using sodium emulsifying |
| | | salts and functional MPC. |

Table 14 above summarises the emulsifying system prepared to target a 20% (sample 368) and a 40% reduction (samples 293 and 366) in sodium used for each formulation, together with the percentage sodium reduction achieved. Normal sodium control IWS and spread (samples 300, and 367, respectively), were also assessed.

Table 15 below shows the composition of the total emulsifying system (TES) for each exemplary cheese formulation prepared in this example. Notably, the TES for each cheese, expressed as a percentage w/w in the final cheese product, was comparable amongst the different formulations.

TABLE 15
Composition of total emulsifying system of processed cheese

| Sample | MPC | TPC | TSC | DSP | DKP | NaCl | TES |
|---|---|---|---|---|---|---|---|
| # | g/20 kg | g/20 kg | g/20 kg | g/20 kg | g/20 kg | g/20 kg | % |
| 300 | 0 | 0 | 530 | 130 | 0 | 100 | 3.3 |
| 293 | 400 | 210 | 0 | 50 | 0 | 100 | 3.3 |
| 367 | 0 | 0 | 112 | 448 | 0 | 160 | 2.8 |
| 366 | 267 | 67 | 0 | 67 | 204 | 160 | 3 |
| 368 | 227 | 0 | 67 | 267 | 0 | 160 | 2.8 |

As shown in Table 16 below, the moisture, fat, and general composition of all products complies with the Codex general standard. Protein composition was comparable between the reduced sodium formulations and their respective, normal sodium controls.

TABLE 16
Composition Summary

| | Moisture | | | K | Na |
|---|---|---|---|---|---|
| Sample # | (%) | Fat % | Protein % | mg/kg | mg/kg |
| 300 | 45.2 | 27.8 | 18.3 | 750 | 14700 |
| 293 | 46.4 | 26.8 | 18.4 | 5680 | 7890 |
| 367 | 56.1 | 25.1 | 13.1 | 369 | 12400 |
| 366 | 55.5 | 25.2 | 14.1 | 5250 | 6890 |
| 368 | 56.2 | 25.2 | 14.0 | 382 | 9900 |

Table 17 shows the melting ability (for IWS) and firmness of the processed cheeses produced in this example. The ability of samples to melt was measured by the modified Schreiber test (see Example One), and firmness of IWS formulations was measured as described in Example One above. Firmness of spreads was measured at 20° C. using penetrometry: a 13 mm diameter metal sphere was inserted at 5 mm/s to a depth of 30 mm, and the maximum force was recorded as the firmness of the spread.

The melting ability of the slices made by all the treatments met the typical minimal melting requirements of the modified Schreiber test used here. The firmness of the reduced-sodium IWS cheese was lower than, but comparable to, that of the normal sodium processed cheese control (sample 300). Likewise, the firmness of the 40%-reduced sodium spread (sample 366) was somewhat greater than the normal sodium control but retained good spreadibility, while the 20%-reduced sodium spread exhibited equivalent firmness to the control formulation.

TABLE 17
Functional & Sensory Summary

| | | Schreiber | |
|---|---|---|---|
| Sample # | Firmness (N) | Melt Score | Sensory preferences/evaluation |
| 300 | 5.8 | 6.2 | Typical, clean flavour |
| 293 | 5.1 | 6.6 | Typical, clean flavour |
| 367 | 1.1 | — | Smooth, salty, clean |
| 366 | 1.6 | — | Smooth, metallic off flavours |
| 368 | 1.1 | — | Smooth, salty, clean |

The pH range for the IWS samples was 5.56 +/− .06
The pH range for the Spread samples was 5.64 +/− .06

This example shows that high quality, desirable processed cheese products of differing formats—here individually-wrapped slices, and spreads—were successfully made with 20% and 40% less sodium than conventional process cheese using a total emulsifying system comprising emulsifying salts and functional MPC.

### Example 6

### Introduction

This example describes the manufacture of exemplary processed cheeses, each targeting an approximately 40% sodium reduction, using a variety of formulations.

Table 18 below summarises the emulsifying system prepared to target a 40% reduction in sodium used for each formulation, together with the percentage sodium reduction achieved.

TABLE 18
Formulations

| Sample # | % Na reduction | Total emulsifying system |
|---|---|---|
| 182 | 42 | Sodium and potassium emulsifying salts and |
| | | functional MPC. |
| 212 | 42 | Sodium and potassium emulsifying salts and |
| | | functional MPC. |
| 219 | 45 | Sodium and potassium emulsifying salts and |
| | | functional MPC. |
| 251 | 41 | Potassium emulsifying salts and functional |
| | | MPC. |
| 280 | 36 | Sodium and potassium emulsifying salts and |
| | | functional MPC. |

Table 19 below shows the composition of the total emulsifying system (TES) for each exemplary cheese formulation prepared in this example. Notably, the TES for each cheese, expressed as a percentage w/w in the final cheese product, was comparable amongst the different formulations.

TABLE 19
Composition of total emulsifying system of processed cheese

| Sample | MPC | TPC | TSC | TPC/TES | MPC/TES | TES |
|---|---|---|---|---|---|---|
| # | (%) | (%) | (%) | (%) | (%) | (% w/w) |
| 182 | 1.45 | 1.61 | 0.25 | 49 | 44 | 3.31 |
| 212 | 1.50 | 2.05 | 0.35 | 53 | 38 | 3.90 |
| 219 | 2.05 | 1.15 | 0.65 | 30 | 53 | 3.85 |
| 251 | 2.00 | 1.95 | 0.0 | 49 | 51 | 3.95 |
| 280 | 1.75 | 1.95 | 0.25 | 49 | 44 | 3.95 |

As can be seen in Tables 20 and 21 below, the exemplary cheeses prepared in this example were compositionally similar, as evidenced by, for example, moisture content.

TABLE 20
Composition Summary

| | Moisture | | | | |
|---|---|---|---|---|---|
| Sample # | (%) | Fat (%) | Protein (%) | K (mg/kg) | Na (mg/kg) |
| 182 | 42.3 | 28.9 | 19.6 | 7390 | 9820 |
| 212 | 41.1 | 28.8 | 20.0 | 8390 | 9790 |
| 219 | 42.1 | 28.2 | 19.9 | 5570 | 9410 |
| 251 | 40.6 | 30.2 | 21.7 | 7510 | 9500 |
| 280 | 40.4 | 29.3 | 21.0 | 8750 | 10300 |

As shown in Table 20 above, the moisture, fat, and general composition of all products complies with the Codex general standard. Protein composition was comparable across all six cheeses.

TABLE 21
Functional & Sensory Summary

| | | Schreiber | |
|---|---|---|---|
| Sample # | Firmness (N) | Melt Score | Sensory preferences/evaluation |
| 182 | 10.3 | 7.1 | Most preferred sample |
| 212 | 7.8 | 5.9 | Savoury, better break, preferred |
| | | | sample |
| 219 | 7.5 | 6.3 | More acidic than control, |
| | | | otherwise comparable, preferred |
| 251 | 11.64 | 6.0 | Most preferred sample |
| 280 | 11.6 | 6.3 | Preferred sample |

Table 21 shows the melting ability and firmness of the processed cheeses produced in this example. The ability of samples to melt was measured by the Schreiber test (see Example One), and firmness was measured as described in Example One above. The melting ability of the slices made by all the treatments met the typical minimal melting requirements of the modified Schreiber test used here. The firmness of the various cheeses varied moderately, but the firmness measurements of reduced sodium processed cheese prepared in this example was generally comparable to control, normal sodium processed cheese. All reduced sodium cheeses exhibited preferred sensory characteristics, and were comparable to normal sodium control cheeses.

This example shows that high quality, desirable processed cheeses made with 40% less sodium than conventional process cheese, but comparable flavour and functional characteristics, were made using total emulsifying systems comprising emulsifying salts and functional MPC.

### Example 7

### Introduction

This example demonstrates the effectiveness of an exemplary emulsification system of the present invention for sodium reduction in processed cheese and processed cheese products, including cheese sauces and cheese powders.

### Materials and Methods

A simple but robust cheese sauce formulation was prepared from a two cheese recipe as a control formulation, as shown below in Table 22 below. A comparable sauce formulation having reduced sodium (also shown in Table 22) was prepared using an exemplary emulsifying system of the present invention. The ratio of skim milk powder to sweet whey powder was adjusted to maintain consistent body in the formulation. Citric acid was adjusted to maintain the same pH.

### Process

Each formulation was processed the same way. All ingredients were placed in a Stephan UM-25 high shear cooker. The mixture was blended for 1 minute at 1500 rpm. The pH was checked and then the blend cooked up to 87° C. using direct steam injection over 4 minutes, at 1500 rpm. The steam was turned off and mixing continued for 2 minutes before increasing the speed to 3000 rpm for 1 minute. The molten product was poured into 250 mL plastic bottles with screw top lids and then cooled in a 4° C. chiller with high air flow.

TABLE 22
Formulations

| | Control | 40% sodium reduction |
|---|---|---|
| Mature Cheddar 1 | 4.00 | 4.00 |
| Mature Cheddar 2 | 3.73 | 3.73 |
| Sweet Whey Powder | 0.39 | 0.50 |
| Skim Milk Powder | 0.39 | 0.27 |
| MPC 4864 | — | 0.12 |
| Salt | 0.01 | 0.01 |
| Trisodium Citrate | 0.28 | 0.06 |
| Tripotassium Citrate | — | 0.11 |
| Citric Acid | 0.02 | — |
| Water | 3.12 | 3.12 |
| Steam Condensate* | 1.21 | 1.38 |

### Results

The products were tested for moisture and pH, as shown in Table 23. The moisture and pH data was very consistent between the two formulations.

TABLE 23
Results

| | | 40% |
|---|---|---|
| | Control | sodium reduction |
| Moisture (%) | 55.0 | 55.6 |
| Fat (%)* | 20 | 20 |
| Protein (%)* | 15 | 15 |
| Sodium (%)* | 1 | 0.6 |
| pH | 5.63 | 5.65 |

*These values were calculated from the moisture content.

When the samples were 24 hours old, a group of 5 processed cheese experts assessed and compared their appearance, texture/consistency and flavour. Both products were smooth and very shiny. Their texture was creamy. The flavour of the samples was determined to be similar, and were described as having clean dairy notes with a strong cheesy flavour.

### Conclusions

This trial demonstrated that the exemplary emulsification systems of the present invention can be used in a processed cheese sauce product to achieve significant sodium reductions without compromising the texture and flavour release. The molten sauce products were determined to have suitable viscosity and hopper life to be passed through a commercial drier and converted into cheese powders adjudged suitable for drying into cheese powders.

### INDUSTRIAL APPLICATION

The present invention provides processed cheeses and processed cheese products and methods of making them, wherein the cheeses have reduced sodium content, and are thus expected to provide both an economic and a health benefit.

1. A method for preparing processed cheese or a processed cheese product comprising:
(a) providing a dairy liquid composition or a gelled dairy composition or both, comprising casein;
(b) cooking the composition or the combination of compositions with emulsifying salts to obtain an emulsion, and
(c) cooling the cooked composition to obtain a processed cheese or processed cheese product;
wherein the emulsifying salts comprise by weight 10-100% of potassium salts.

2. The method according to claim 1 wherein the emulsifying salts comprise potassium citrate.

3. The method according to claim 1 wherein the emulsifying salts comprise trisodium citrate.

4. The method according to claim 1 wherein the emulsifying salts comprise tripotassium citrate and trisodium citrate.

5. The method according to claim 4 wherein the emulsifying salts consist of tripotassium citrate and trisodium citrate.

6. The method according to claim 1 wherein the emulsifying salts comprise or consist of tripotassium citrate and
i. less than about 40% w/w trisodium citrate;
ii. less than about 35% w/w trisodium citrate;
iii. less than about 30% w/w trisodium citrate;
iv. less than about 25% w/w trisodium citrate;
v. less than about 20% w/w trisodium citrate;
vi. less than about 15% w/w trisodium citrate;
vii. less than about 10% w/w trisodium citrate;
viii. less than about 5% w/w trisodium citrate;
ix. less than about 1% w/w trisodium citrate.

7. A method for preparing processed cheese or a processed cheese product comprising:
(a) providing a dairy liquid composition or a gelled dairy composition or both,
(b) cooking the composition or the combination of compositions with an emulsifying system to obtain an emulsion, and
(c) cooling the cooked composition to obtain a processed cheese or a processed cheese product;
wherein the emulsifying system comprises, consists essentially of or consists of:
i. by weight 10-100% of potassium salts; or
ii. by weight 0-100% of sodium salts; or
iii. any combination of i) and ii); and
iv. by weight 10-100% one or more milk protein source.

8. The method according to claim 7 wherein the milk protein source is functionalised for emulsification.

9. The method according to claim 7 wherein the milk protein source comprises casein, and wherein at least part of the casein has a proportion of its divalent ions replaced with sodium or potassium ions.

10. (canceled)

11. The method according to claim 7 wherein the emulsifying system comprises, consists essentially of, or consists of by weight 20-70% of potassium salts and by weight 20-70% one or more milk protein source.

12. The method according to claim 7 wherein the emulsifying system comprises less than about 40% by weight of sodium salts.

13. The method according to claim 12 wherein the emulsifying system comprises less than about 20% by weight of sodium salts.

14. A method for preparing processed cheese or a processed cheese product comprising:
(a) providing a dairy liquid composition or a gelled dairy composition or both, comprising casein;
(b) cooking the composition or the combination of compositions with an emulsifying system to obtain an emulsion, and
(c) cooling the cooked composition to obtain a processed cheese or a processed cheese product;
wherein the emulsifying system comprises at least one milk protein source, for example a milk protein concentrate, and at least one emulsifying salt.

15. (canceled)

16. The method according to claim 14 wherein the emulsifying system comprises
i. from about 1% to about 15% w/w;
ii. from about 3% to about 6% w/w;
iii. from about 3% to about 5.5% w/w;
iv. from about 3% to about 5% w/w;
v. from about 3% to about 4.5% w/w;
vi. from about 3% to about 4% w/w; or
vii. from about 3.5% to about 4% w/w;
of the processed cheese or the processed cheese product.

17. The method according to claim 14 wherein the emulsifying system comprises, consists essentially of, or consists of at least one milk protein source and at least one emulsifying salt, and wherein the at least one potassium emulsifying salt comprises at least 10% by weight of the emulsifying system.

18. The method according to claim 17 wherein the at least one emulsifying salt comprises at least about 20% by weight of the emulsifying system.

19. The method according to claim 14 wherein the milk protein source is a calcium-reduced milk protein source.

20. The method according to claim 14 wherein the milk protein source comprises between 0.1% and 99.9% of the emulsifying system.

21. The method according to claim 14 wherein the emulsifying system comprises any one of:
i. by weight 20-75% of potassium salts;
ii. by weight 20-70% of potassium salts;
iii. by weight 30-70% of potassium salts;
iv. by weight 30-60% of potassium salts;
v. by weight 35-60% of potassium salts;
vi. by weight 40-60% of potassium salts;
vii. by weight 45-60% of potassium salts;
viii. by weight 45-55% of potassium salts; or
ix. by weight about 50% of potassium salts;
and any one of
x. by weight 20-75% of a milk protein source;
xi. by weight 20-70% of a milk protein source;
xii. by weight 30-70% of a milk protein source;
xiii. by weight 30-60% of a milk protein source;
xiv. by weight 35-60% of a milk protein source;
xv. by weight 40-60% of a milk protein source;
xvi. by weight 45-60% of a milk protein source;
xvii. by weight 45-55% of a milk protein source; or
xviii. by weight about 50% of a milk protein source.

22. The method according to claim 21 including any combination of i) to ix) and x) to xviii), wherein the emulsifying system comprises less than about 25% by weight sodium emulsifying salts.

23. The method according to claim 22 wherein the emulsifying system comprises
i. less than about 20% by weight sodium emulsifying salts;
ii. less than about 15% by weight sodium emulsifying salts;
iii. less than about 10% by weight sodium emulsifying salts;
iv. less than about 5% by weight emulsifying sodium salts, or
v. less than about 1% w/w sodium emulsifying salts.

24. (canceled)

25. The method according to claim 14 wherein the emulsifying salt comprising part of the emulsifying system is a citrate salt.

26. The method according to claim 25 wherein the emulsifying salt is tripotassium citrate.

27. An emulsifying system for processed cheese, wherein the emulsifying system comprises, consists essentially of, or consists of a milk protein source and at least one potassium emulsifying salt, wherein the at least one potassium emulsifying salt comprises at least 10% by weight of the emulsifying system.

28. The emulsifying system of claim 27 wherein the at least one potassium emulsifying salt comprises
i. at least about 25% by weight of the emulsifying system; or
ii. at least about 30% by weight of the emulsifying system; or
iii. at least about 35% by weight of the emulsifying system; or
iv. at least about 40% by weight of the emulsifying system; or
v. at least about 45% by weight of the emulsifying system; or
vi. at least about 50% by weight of the emulsifying system; or
vii. at least about 55% by weight of the emulsifying system; or
viii. at least about 60% by weight of the emulsifying system.

29. The emulsifying system according to claim 27 wherein the potassium emulsifying salt is a potassium citrate, such as tripotassium citrate.

30. The emulsifying system according to claim 27 wherein the milk protein source comprises
i. at least about 25% by weight of the emulsifying system; or
ii. at least about 30% by weight of the emulsifying system; or
iii. at least about 35% by weight of the emulsifying system; or
iv. at least about 40% by weight of the emulsifying system; or
v. at least about 45% by weight of the emulsifying system; or
vi. at least about 50% by weight of the emulsifying system; or
vii. at least about 55% by weight of the emulsifying system; or
viii. at least about 60% by weight of the emulsifying system.

31. A processed cheese or a processed cheese product, wherein the processed cheese or product comprises:
(a) by weight 0.1-6% of an emulsifying system; or
(b) by weight 0.1-6% of emulsifying salts;
wherein the emulsifying system comprises, consists essentially of, or consists of:
i. by weight 10-100% of potassium salts; or
ii. by weight 0-100% of sodium salts; or
iii. any combination of i) and ii); and
iv. by weight 10-100% one or more milk protein source;
or wherein the emulsifying salts comprise by weight 10-100% of potassium salts.

32. The processed cheese or processed cheese product according to claim 31 wherein the processed cheese or processed cheese product comprises
i. less than 1% w/w sodium emulsifying salts,
ii. less than about 0.9% w/w sodium emulsifying salts,
iii. less than about 0.8% w/w sodium emulsifying salts,
iv. less than about 0.7% w/w sodium emulsifying salts,
v. less than about 0.6% w/w sodium emulsifying salts,
vi. less than about 0.5% w/w sodium emulsifying salts,
vii. less than about 0.4% w/w sodium emulsifying salts,
viii. less than about 0.3% w/w sodium emulsifying salts,
ix. less than about 0.2% w/w sodium emulsifying salts,
x. less than about 0.1% w/w sodium emulsifying salts, or
xi. less than about 0.05% w/w sodium emulsifying salts.

33. The processed cheese or processed cheese product of claim 31 wherein the processed cheese or processed cheese product is a sauce, powder, paste, dip, spread, a ready-made or ready-to-eat food product or meal comprising processed cheese or a processed cheese product.

34. The processed cheese or processed cheese product according to claim 32 wherein the processed cheese comprises no added sodium emulsifying salts.

35. The processed cheese or processed cheese product according to claims 32 wherein the processed cheese or processed cheese product comprises an emulsifying system consisting essentially of or consisting of a milk protein concentrate and tripotassium citrate.

36. The emulsifying system according to claim 27 wherein the emulsifying system consists essentially of or consists of a milk protein concentrate and tripotassium citrate.
